(19) United States
(12) Patent Application Publication
(10) Pub. No.: US 2023/0394447 A1
(43) Pub. Date: Dec. 7, 2023

(54) PAYMENT METHOD AND SYSTEM FOR PURCHASING DIGITAL CURRENCY

(71) Applicant: NAVER WEBTOON LTD., Seongnam-si (KR)

(72) Inventors: Hyo Jung KIM, Seongnam-si (KR); Da Young KIM, Seongnam-si (KR); Yeon Ju CHA, Seongnam-si (KR); Choon Hae LEE, Seongnam-si (KR); Ji Hoon HA, Seongnam-si (KR); Seung Hwan KIM, Seongnam-si (KR); Yun Il JUNG, Seongnam-si (KR); Ki Hyun PARK, Seongnam-si (KR); Chang Min JEON, Seongnam-si (KR); Se Jin CHA, Seongnam-si (KR); Jae Han YOON, Seongnam-si (KR); Yun Yeon CHOI, Seongnam-si (KR)

(21) Appl. No.: 18/451,487

(22) Filed: Aug. 17, 2023

Related U.S. Application Data
(63) Continuation of application No. PCT/KR2022/002337, filed on Feb. 17, 2022.

(30) Foreign Application Priority Data
Feb. 17, 2021 (KR) 10-2021-0021469

(51) Int. Cl. G06Q 20/06; G06Q 20/22; G06Q 20/12

(52) U.S. Cl. CPC G06Q 20/065; G06Q 20/227; G06Q 20/123

(57) ABSTRACT

A payment method for purchase of digital currency includes receiving selection information for selecting a specific payment type among a plurality of different payment types related to digital currency, in relation to a user account; registering a payment condition corresponding to the specific payment type to the user account by using the selection information; and starting an electronic payment process to purchase the digital currency for the user account in response to occurrence of a payment event related to the payment condition at the user account.

### CROSS-REFERENCE TO RELATED APPLICATIONS

This is a continuation application of International Application No. PCT/KR2022/002337, filed Feb. 17, 2022, which claims the benefit of Korean Patent Application No. 10-2021-0021469, filed Feb. 17, 2021.

### BACKGROUND OF THE INVENTION

### Field of Invention

The present invention relates to a payment method and system for purchasing digital currency.

### Description of Related Art

As technologies develop, a utilization degree of digital devices is increased. Especially, electronic devices (e.g., smartphones, tablet PC, etc.) are provided with various functions such as web surfing, listening to music and video contents viewing, using the Internet, as well as a communication function such as voice calls or text messages.

Owing to such popularization of electronic devices, a contents industry shows a remarkable growing trend. Contents mean various types of information provided through the Internet or computer communications, etc. For instance, contents may include WebComics, web novels, music, e-books, stories, moving images, TV program images, pictures, etc.

A representative example of contents which are being actively consumed is WebComics. WebComics means a cartoon uploaded and distributed through an internet communication network, and is a compound word of web and comics.

As consumption of WebComics is steadily increased, various providers (or WebComics-related service providers) are developing various services so that many consumers can be interested in WebComics and consume WebComics. As an example, various providers (or WebComics-related service providers) provide an amount of WebComics corresponding to one book to consumers by dividing it into a plurality of episodes, and induce continuous consumption of the episodes.

As another example, Korean Laid-Open Patent No. 10-2015-0085195 (a method and system for providing animation effect-applied WebComics to a user terminal) provides consumers with WebComics to which animation effects have been applied, and proposes a method to enhance a consumer's understanding of WebComics.

In order to induce consumers' consumption and interests in WebComics, various research is actively ongoing.

### BRIEF SUMMARY OF THE INVENTION

The present invention relates to a payment method and system for purchasing digital currency, capable of allowing contents consumption to be continuously performed.

More specifically, the present invention relates to a payment method and system for purchasing digital currency, capable of providing a new payment method for digital currency, and capable of allowing contents consumption to be continuously performed.

Further, the present invention relates to a payment method and system for purchasing digital currency, capable of providing a new type of rewards for digital currency, and capable of allowing a payment for digital currency to be continuously performed.

Further, the present invention relates to a payment method and system for purchasing digital currency, capable of allowing a user to consume contents more economically.

In order to achieve these and other advantages and in accordance with the purpose of this specification, there is provided an electronic payment method for purchase of digital currency, the method for performing a payment related to digital currency used to view contents, comprising: receiving selection information for selecting a specific payment type among a plurality of different payment types related to the digital currency, in relation to a user account; registering a payment condition corresponding to the specific payment type to the user account, by using the selection information; and starting an electronic payment process to purchase the digital currency for the user account, in response to occurrence of a payment event related to the payment condition at the user account.

Further, there is provided an electronic payment system for performing a payment related to digital currency used to view contents, the system comprising: a communication unit configured to receive selection information for selecting a specific payment type among a plurality of different payment types related to the digital currency, in relation to a user account; and a controller configured to register a payment condition corresponding to the specific payment type to the user account, by using the selection information, wherein the controller starts an electronic payment process to purchase the digital currency for the user account, in response to occurrence of a payment event related to the payment condition at the user account.

Further, there is provided a program storable in a computer-readable recording medium, the program being executed in an electronic device by one or more processors and comprising commands configured to: receive selection information for selecting a specific payment type among a plurality of different payment types related to digital currency, in relation to a user account; register a payment condition corresponding to the specific payment type to the user account, by using the selection information; and start an electronic payment process to purchase the digital currency for the user account, in response to occurrence of a payment event related to the payment condition at the user account.

As aforementioned, in the payment method and system of the present invention, whenever a payment event related to payment of digital currency occurs, a payment for purchase of digital currency is started. This may allow a payment for digital currency to be continuously performed. As a result, as purchase of digital currency used to view content is continuously performed, consumption of contents may be continuously performed.

Further, at the time of viewing contents, a user convenience in that he or she need not perform an electronic payment for purchase of digital currency every time may be enhanced. And the user may freely view contents by using digital currency owned at any time.

That is, in the payment method and system of the present invention, an electronic payment process is automatically started based on the occurrence of a payment event related to a payment condition. This may provide a user convenience in that he or she need not additionally perform an electronic payment. Further, through an electronic payment method for purchase of digital currency which allows contents viewing to be continuously performed, a contents provider may effectively induce contents consumption by a consumer and may ensure the consumer's continuous contents consumption. This may prevent the consumer from leaving.

Further, as the present invention provides various payment types and payment conditions, a user may design an electronic payment method suitable for his or her taste and situation.

### BRIEF DESCRIPTION OF THE DRAWINGS

FIG. 1 is a block diagram for explaining a payment method and system according to the present invention.

FIG. 2 is a conceptual view for explaining a user environment to which contents are provided, in a payment method and system according to the present invention.

FIG. 3 is a flowchart for explaining a payment method according to the present invention.

FIG. 4 is a conceptual view for explaining a first payment type among a plurality of payment types according to the present invention.

FIG. 5 is a conceptual view for explaining a second payment type among a plurality of payment types according to the present invention.

FIGS. 6 to 8 are conceptual views for explaining a payment method according to the present invention.

FIG. 9 is a conceptual view for explaining a payment history of a user account according to the present invention.

FIGS. 10A and 10B are conceptual views for explaining a general payment method according to the present invention.

FIGS. 11A and 11B are conceptual views for explaining a change of a payment condition according to the present invention.

FIGS. 12A and 12B are conceptual views for explaining a method to stop an electronic payment according to the present invention.

FIGS. 13A to 13C are conceptual views for explaining a method to release an electronic payment according to the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, terms such as “module” and “unit” may be used to refer to elements or components. Use of such terms herein is merely intended to facilitate description of the specification. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of features, numbers, steps, functions, several components, or combinations thereof, disclosed in the specification, and it is also understood that greater or fewer features, numbers, steps, functions, several components, or combinations thereof may likewise be utilized.

The present invention relates to an electronic payment method and system for purchasing digital currency, and is to provide a payment environment which allows contents consumption to be continually performed.

An electronic payment system explained in the present invention is a system including a contents providing system or connected thereto, and digital currency purchased by the electronic payment system may be utilized to view contents provided from a contents providing system.

In the present invention, a method to purchase digital currency will be explained by using the term of “electronic payment system”. However, an electronic payment function provided from the electronic payment system may be one function provided from “contents providing system”. In this case, it will be apparent to those skilled in the art that the “electronic payment system” may be referred to as the “contents providing system”.

“Contents” explained in the present invention may mean various types of information provided through the Internet or computer communications. Types of contents which may be applicable to the present invention may greatly vary. For instance, at least one of contents such as WebComics, web novels, music, e-books, stories, moving images, TV program images and pictures may be provided in the present invention.

Hereinafter, contents corresponding to a WebComics will be explained for convenience. Here, WebComics is a compound word of web and comics, and means a cartoon or a comics provided through an internet communication network.

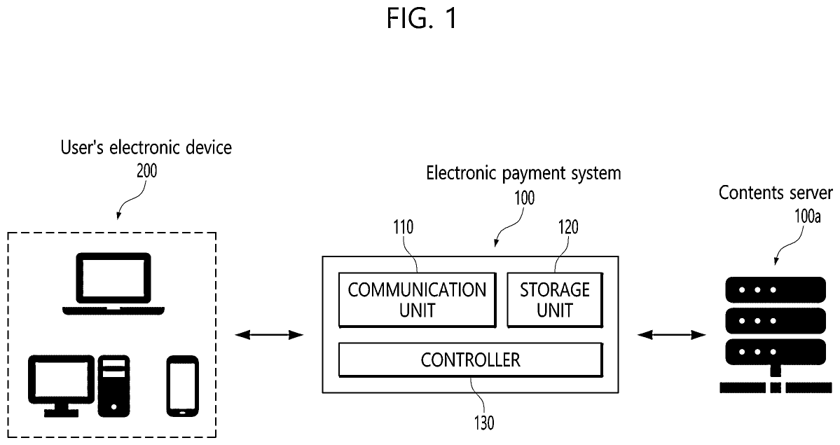

The contents corresponding to a WebComics (hereinafter, will be referred to as “WebComics contents”) may be provided onto an electronic device 200 through a payment method and system according to the present invention. Thus, a user may use WebComics contents provided through the payment method and system through the electronic device 200 shown in FIG. 1.

In the present invention, WebComics contents may be comprised of a plurality of sub contents. The plurality of sub contents may constitute series of WebComics contents. Here, the series may mean consecutive sections of contents.

In the present invention, for prevention of confusion between WebComics contents and sub contents, “sub contents” will be referred to as “episodes.”

Sub contents and episodes are terms used for a conceptual distinguishment, and it will be apparent to those skilled in the art that they all correspond to “contents.”

In this case, WebComics contents may be comprised of a plurality of episodes, and the plurality of episodes may be the same or at least-partially different product types. Here, the product type of an episode may be either a “free product type” or a “charged product type”. An episode having a “free product type” may mean an episode that a user can directly use without payment, such as digital currency, coupons or a viewing right (or a usage right) in order to view (or use) an episode.

In contrast, an episode having a “charged product type” may mean an episode that a user can use after a payment, such as digital currency, coupons or a viewing right (or a usage right) in order to view (or use) an episode. That is, contents provided in the present invention may be comprised of at least one episode, and each episode may either be a charged product type which allows viewing through a payment of the digital currency, or a free product type which allows viewing without a payment of the digital currency.

Here, the charged product type of a specific episode among the at least one episode may be converted into a free product type as a preset time lapses. In this case, the specific episode converted into a free product type can be viewed without a payment of digital currency.

Here, the preset time may be variously set, and whether the preset time has lapsed or not may be counted based on an uploaded date or time of the charged product type contents. For instance, a specific episode of a charged product type may be converted into free product type contents after 3 days based on the uploaded date of the specific episode on a contents providing service.

In a payment system according to the present invention, as a payment method for purchasing digital currency used to view a charged product type episode, when a user's request to view a charged product type episode is received, digital currency retained (kept) at a user account may be subtracted and the charged product type episode may be provided to an electronic device of the user.

Meanwhile, an electronic device 200 (refer to FIG. 1) means an electronic device 200 of a user, and has no limitation in its type, only that it can output WebComics contents provided through a contents providing system of the present invention.

As shown in FIG. 1, the electronic device 200 may be a portable phone, a smart phone, a notebook computer, a laptop computer, a slate PC, a tablet PC, an ultrabook, a desktop computer, a digital broadcasting terminal, a personal digital assistant (PDA), a portable multimedia player (PMP), a navigation, a wearable device (e.g. a smartwatch), a glass type terminal (a smart glass), a head mounted display (HMD), etc.

In the present invention, “digital currency” is currency used in a digital manner (i.e., stored in a computer for usage, or used on a network), and may be referred to as “cyber money.” Such digital currency may mean currency having a monetary value stored in an electronic manner, i.e., electronically.

Digital currency may exist by being stored in an electronic manner on a payment system 100 (refer to FIG. 1) according to the present invention, or a server associated therewith.

Digital currency may be stored by being interworked with a user account. That is, a predetermined number of units of digital currency purchased by a user may exist by being interworked with a user account.

Such digital currency is utilized for economic consumption activities, and may include social currency, internet coupons, mobile coupons, game money and so on, as an example.

Digital currency may be used at different places based on its issuance provider. For instance, digital currency issued by company A may be used only at a service platform provided by company A (e.g., a WebComics service, a shopping mall, etc. operated by company A). If there are a plurality of service platforms provided by company A, the digital currency issued by company A may be commonly used at the plurality of service platforms by a policy of company A. For instance, digital currency issued by company A may be commonly used at a plurality of different service platforms such as a WebComics service platform, a moving image providing platform and an OTT service platform. Such digital currency may be commonly used among service platforms of different providers by their cooperation (tie-up).

Further, digital currency may be referred to by various terms, and may be named by a provider. For instance, the digital currency may be called as an arbitrary name such as soybeans, beans, acorns and corns. In the descriptions and the drawings of the present invention, such digital currency will be referred to as “cookies.” Thus, in the present invention, the term of “cookies” will be used together with the term of “digital currency,” and the term of “cookies” will be understood as digital currency.

Digital currency may be purchased by an electronic settlement (payment). The electronic settlement (payment) explained in the present invention means a user's (or a consumer's) payment for purchase of a product or a service, by using an electronic device 200 to which a tradable program for currency having a monetary value or a function is connected. Such an electronic payment may be understood as a meaning which includes online card payment, point payment, account transfer, etc.

Here, a product may mean digital currency in the present invention. In the present invention, an electronic payment may be used together with “payment.”

In the present invention, “purchase of digital currency through an electronic payment” may be expressed as “charging of digital currency.” That is, a user may “purchase” or “charge” digital currency by an electronic payment. Such digital currency purchased or charged may exist by being interworked with a user account.

Digital currency of the present invention may have a plurality of attributes or types. The attributes or types of digital currency may be categorized according to whether digital currency has been “purchased” through an electronic payment.

More specifically, digital currency having a first attribute (or a first type) among a plurality of attributes is digital currency purchased through an electronic payment. In the present invention, such digital currency obtained by a purchase action may be referred to as “purchase digital currency” or “purchased digital currency.” “Purchase digital currency” may mean digital currency which is to be provided to a user account, in correspondence to an electronic payment.

Further, digital currency having a second attribute (or a second type) among a plurality of attributes is digital currency which is to be provided to a user account separately from a purchase behavior of digital currency through an electronic payment, and may be referred to as “bonus digital currency”.

Such “bonus digital currency” may mean digital currency which is to be provided to a user account separately from a purchase behavior of digital currency through an electronic payment, to a user's benefit (compensation or reward). Such bonus digital currency may be used together with the terms of “additional digital currency,” “reward digital currency,” “compensation digital currency,” etc.

In the present invention, a proper amount of bonus digital currency may be supplied for continuous purchase of digital currency.

An amount explained in the present invention is a value indicating the amount of digital currency. When there exists a number of units of digital currency, the amount may mean the amount according to the unit. In the present invention, the “amount” may be used together with the “number.”

In the present invention, the number of units of digital currency provided to a user account in correspondence to a price payment through an electronic manner is referred to as a “purchase amount.” In the present invention, the “purchase amount” may be used together with a “charging amount.”

Further, in the present invention, the number of units of digital currency provided to a user account separately from a price payment is referred to as an “additional amount.” In the present invention, the “additional amount” may be used together with a “bonus amount,” a “reward amount” or a “compensation amount.”

In the present invention, an electronic payment for purchase of digital currency may have a plurality of electronic payment types (or methods). A first payment method (or a first electronic payment method) may be understood as a one-time payment method, which may mean a payment method to purchase digital currency only when there is a user's request for purchase of digital currency.

In the case of the first payment method, after an electronic payment process is started and completed by a user, an additional electronic payment is not performed until the user requests for an additional payment, because the first payment method has a one-time payment attribute.

A second payment method may be understood as an automatic payment method, which may mean that an electronic payment process for purchase of digital currency is started without a user's request. According to the second payment method, when a pre-registered electronic payment means (e.g., a credit card, a bank account) is available, purchase of digital currency may be performed based on start of an electronic payment process even if there is not a user's request.

In the case of the second payment method, a payment condition may be registered to the user account, and the payment system 100 may perform (or start) an electronic payment process based on the occurrence of a payment event which satisfies the payment condition registered to the user account. Monitoring such a payment event and performing an electronic payment process according to the payment event may be performed by the payment system 100 of the present invention without a user's intervention. The second payment method may be referred to as “automatic payment.” The “automatic payment” may mean that payment for purchase of digital currency is performed under control of the electronic payment system 100 according to a user's consent. In the present invention, “automatic payment” and “automatic charging” may be used together.

In the present invention, continuous purchase of digital currency is induced through such a second payment method, and the following descriptions will be explained with a focus on the second payment method.

Meanwhile, an electronic payment may be performed a plurality of times at a user account, and the order may be counted whenever an electronic payment is performed. For instance, if an electronic payment is performed again after eight electronic payments are performed, this may be a ninth electronic payment.

In the present invention, in a case where electronic payments for purchase of digital currency are performed repeatedly (or a plurality of times) at a user account, the order of a payment (or the sequence of a payment) may be referred to as “the number of times.” A first payment may mean a payment performed firstly or for the first time after a preset reference time at a user account.

The number of times of payment may be counted as a first payment, a second payment, a third payment, etc. whenever payments are performed. In the present invention, “the number of times” may be used together with “frequency” or “order.”

Whenever an electronic payment is performed, the payment system 100 of the present invention may perform counting for the number of times of the electronic payment. Such counting may be performed when an electronic payment according to a second electronic payment method (automatic payment method) is performed.

Performing counting means doing counting for the number of times of a payment.

In the present invention, the second payment method corresponding to an automatic payment may include “a plurality of payment types” related to purchase of digital currency. The electronic payment system 100 may receive selection information for selecting a specific payment type among a plurality of payment types, from a user account.

“A plurality of payment types” explained in the present invention define when and how a payment (especially, a second type of payment (automatic payment)) is to be performed, which may mean defining a condition which generates a payment event with respect to an automatic payment.

In the present invention, a plurality of payment types are explained as “first payment type” and “second payment type” as an example. However, the present invention is not limited to this. More detailed descriptions will be explained later.

In the present invention, “a specific payment type” may mean at least one of the plurality of payment types. More specifically, a specific payment type may mean a payment type specified based on selection information received from a user account.

Further, a factor to determine when and how to perform an electronic payment is referred to as “a payment condition” in the present invention. The “payment condition” may be specified by a user's selection or a provider.

Meanwhile, in the present invention, a “user” may mean a subject who purchases digital currency and consumes (buys or views) WebComics contents. In the present invention, the user may be used together with “consumer,” “user account,” “user's electronic device,” “user electronic device 200,” “subscriber,” “viewer” or “crowd.”

A user may purchase digital currency based on an “account (i.e., a user account)” pre-registered to the electronic payment system of the present invention, and may consume (buy or view) contents by using the purchased digital currency.

The “account” can be generated through a page associated with the electronic payment system 100. Alternatively, the “account” can be also generated in at least one system associated with the electronic payment system 100 of the present invention.

Thus, in this specification, all accounts based on the electronic payment system of the present invention will be referred to as “accounts pre-registered to the electronic payment system of the present invention” without a division of a system to which an account has been provided.

For understanding of the present invention, a data transmission/reception flow will be explained.

Firstly, information transmission to the electronic payment system 100 from a user (i), or information transmission to a user from the electronic payment system 100 (ii) may substantially mean information transmission to the electronic payment system 100 from an “electronic device 200 logged-in with a user account” (i), or information transmission to an “electronic device 200 logged-in with a user account” from the electronic payment system 100 (ii).

However, in this specification, they will not be distinguished from each other definitely for convenience of explanations, and will be explained with a subject of a “user account.” For instance, information transmission from an “electronic device 200 logged-in with a user account” (i), or information reception by an “electronic device 200 logged-in with a user account” (ii) will be explained as “information transmission from a user account” (i) or “information reception by a user account” (ii).

Further, a “provider” used in the present invention may mean a subject who operates the electronic payment system 100. That is, in the present invention, a provider may be understood as the electronic payment system 100 according to the present invention or a contents providing system.

Hereinafter, a payment method and system for purchasing digital currency used to view contents will be explained in more detail with reference to the attached drawings, based on the above-explained terms. FIG. 1 is a block diagram for explaining a payment method and system according to the present invention.

As shown in FIG. 1, the electronic payment system 100 may include at least one of a communication unit 110, a storage unit 120 and a controller 130.

Here, the communication unit 110 may provide (or transmit) contents (hereinafter, “WebComics contents” will be used as an example) onto the electronic device 200 through wired or wireless communications.

Further, the communication unit 110 may transceive (transmit and receive) various data for performing an electronic payment to/from the electronic device 200.

Next, the storage unit 120 may store various information related to provision of WebComics contents and charging of digital currency. The storage unit 120 may include at least one contents server 100a (or contents database (DB)) including a plurality of WebComics contents.

Hereinafter, contents server and contents DB will be referred to as contents server without a division. That is, it is obvious that contents server explained in the present invention may be also understood as contents DB.

Further, the contents server 100a for storing a plurality of WebComics contents may exist as a separate component from the storage unit 120. In this case, the electronic payment system 100 may provide WebComics contents stored in the contents server 100a to the user's electronic device 200 by controlling the contents server 100a.

Further, the storage unit 120 may store therein information on a user who has subscribed to a service provided from the electronic payment system of the present invention (e.g., a WebComics providing service). Such user information may include information about a user account (e.g., identification (ID)). A user may use WebComics contents by logging-in a service provided from the electronic payment system 100 of the present invention, with a user account.

Further, the storage unit 120 may store therein various types of information associated with a user account. For instance, the storage unit 120 may store therein user history information associated with the user's electronic device 200.

Here, the user “history information” may include various information generated from the electronic payment system 100 of the present invention, such as information on a payment method received from a user account, information on a payment type, information on a payment condition, information on a payment event related to a payment and information on a purchase history of digital currency. In the present invention, the term of “history information” may be used together with a “payment history.”

Next, the controller 130 may perform a series of controls for performing the electronic payment method of the present invention.

More specifically, the controller 130 may monitor whether a payment event which satisfies a payment condition has occurred at a user account. The controller 130 may perform an electronic payment process for purchasing digital currency with respect to a user account according to a monitoring result. Further, the controller 130 may count the number of times of an electronic payment performed at the user account, and may control the storage unit 120 to store a counting result. The controller 130 may provide bonus digital currency to the user account based on the counting result, and detailed descriptions will be explained hereinafter.

The controller 130 may include any type of device capable of processing data, such as a processor. Here, the processor may refer to a hardware built-in data processing device having a circuit physically structured to perform a function expressed in a code or instructions included in a program. Examples of the hardware built-in data processing device may include processing devices such as a microprocessor, a central processing unit (CPU), a processor core, a multiprocessor, an application-specific integrated circuit (ASIC), a field programmable gate array (FPGA), etc., but the scope of the present invention is not limited thereto.

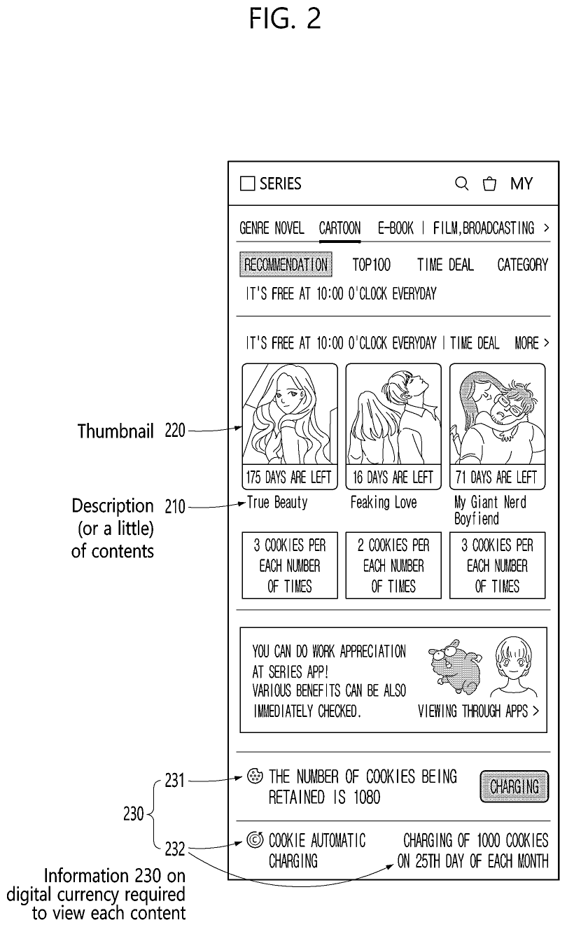

Hereinafter, an electric payment for purchasing digital currency will be explained in more detail with reference to the attached drawings, based on the terms used in the present invention and the configuration of the electronic payment system 100. FIG. 2 is a conceptual view for explaining a user environment to which contents are provided, in a payment method and system according to the present invention.

As shown in FIG. 2, the electronic payment system 100 according to the present invention may provide a user environment for providing WebComics contents. Such a user environment may be provided through an application installed at the electronic device 200, or a webpage accessed through the electronic device 200. Such a user environment may mean a page including visual information provided through a display unit of the electronic device 200, and may be referred to as a graphic user interface.

As shown in FIG. 2, such a user environment may be configured variously, and may be configured to provide contents (e.g., WebComics contents) to a user. For instance, as shown, a page provided to the electronic device 200 may include at least one of i) a description (or a title) 210 about a plurality of contents (e.g., a plurality of WebComics contents), ii) a thumbnail (or a mark) 220 indicating each of WebComics contents, and iii) at least one of information 230 on digital currency required to view each content. A configuration of a screen provided to a page may be modified very greatly.

A user may check WebComics contents and select desired contents for viewing, through a page provided through the electronic device 200.

Herein, if a type of contents selected by a user is a charged product type, the controller 130 may subtract digital currency retained at a user account, and then may provide the charged product type of contents to the user.

More specifically, in a case where a product type of specific contents (e.g., specific episodes) selected by a user is a charged product type, if an item corresponding to specific contents is selected on the electronic device 200, the controller 130 may determine whether a user account logged-in to the electronic device has a usage right (or a viewing right) required to view (or use) the specific contents.

Here, the determination of a usage right (or a viewing right) may be understood as a determination whether a user account logged-in to the electronic device 100 has a right to use (or view) the specific contents.

Meanwhile, “a user account has a usage right or a viewing right for charged product type of contents” may be understood as “a user account has digital currency, coupons or a viewing right (or a usage right) which can be used (or paid) to use charged product type of contents.”

If charged product type of specific contents are selected, the controller 130 may perform a payment process of i) paying digital currency, ii) using coupons, or iii) using (or subtracting) a viewing right, each retained at the user account. The controller 130 may provide charged product type of contents, to the user account which has completed a payment for viewing (or using) the charged product type of contents through such a payment process.

In the present invention, “providing contents onto an electronic device” may mean transmitting contents-related information to the electronic device 200 such that contents are output onto the electronic device.

In a case where a free product type of contents is selected from a user, the controller 130 may provide the selected contents to the user's electronic device 200 without determining whether the user has a right to use the contents.

Meanwhile, even in the case of a free product type of contents, the controller 130 may provide the contents only to the electronic device 200 logged-in with a user account pre-registered to the electronic payment system of the present invention. For instance, a request to view free product type of contents is received from the electronic device 200, the controller 130 may check whether the electronic device has been logged-in with a user account. After checking that the electronic device 200 has been logged-in with the user account, the controller 130 may provide the free product type of contents onto the electronic device. Here, if the electronic device 200 has not been logged-in with the user account, the controller 130 may perform a process for log-in.

As shown in FIG. 2, in the electronic payment system according to the present invention, if there is a request to view charged product type of contents, the charged product type of contents may be provided to the user through provision (or subtraction) of digital currency already retained at the user account.

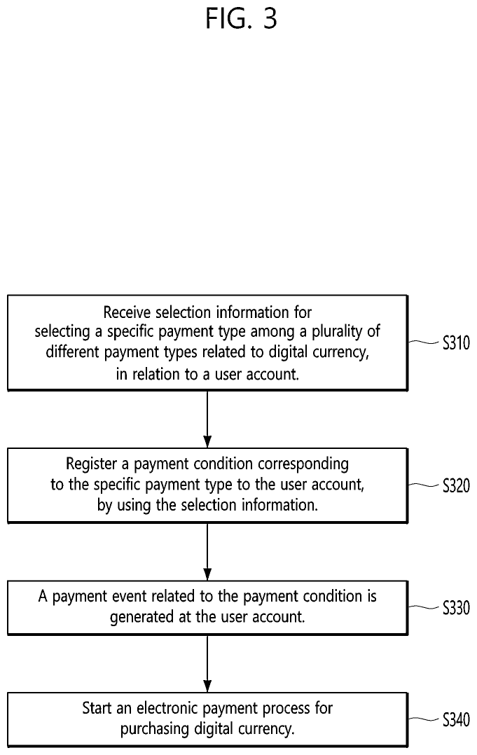

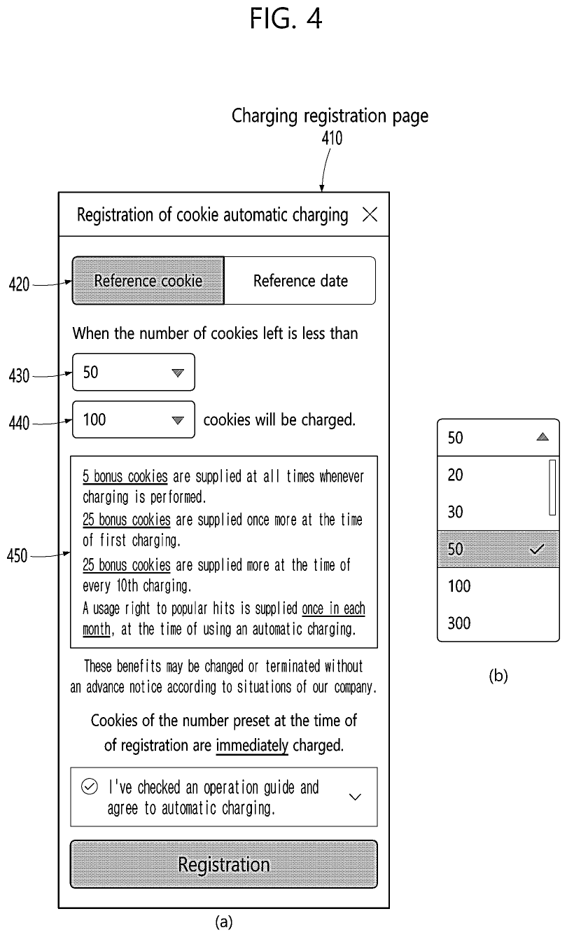

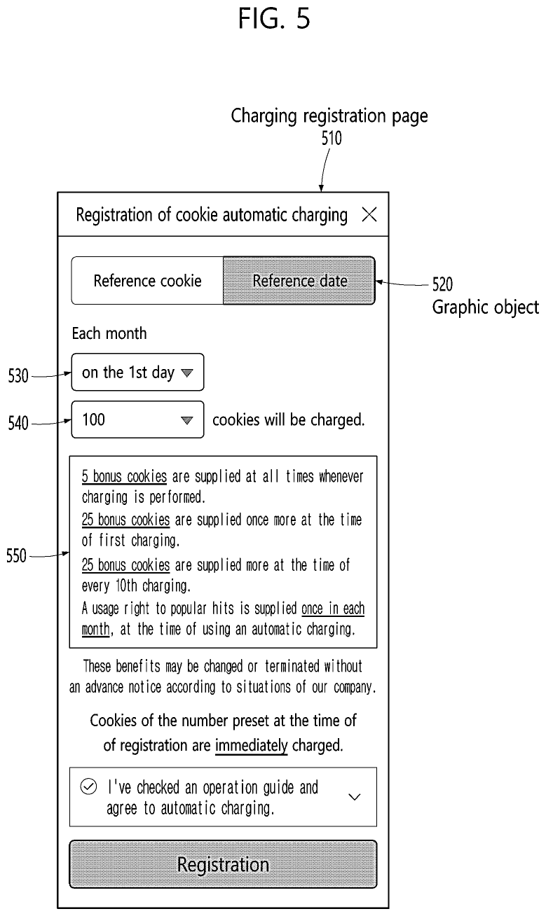

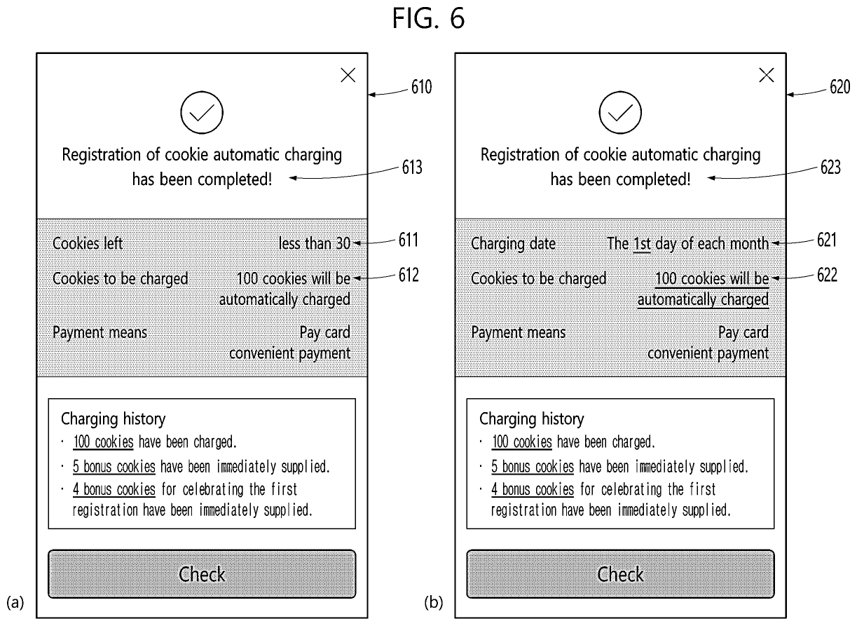

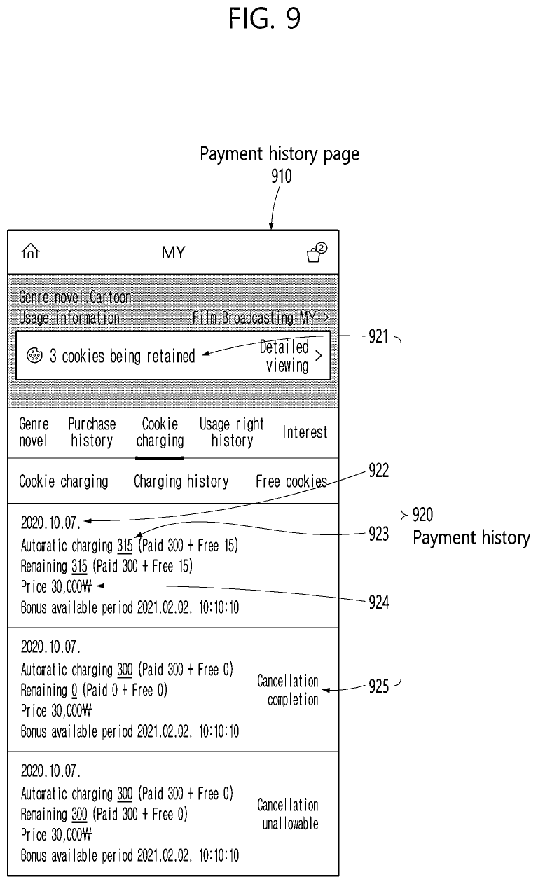

Hereinafter, a method to induce continuous purchase of digital currency will be explained in more detail with reference to the attached drawings, by explaining a digital currency purchasing method through an automatic payment method among digital currency purchasing methods. FIG. 3 is a flowchart for explaining a payment method according to the present invention. FIG. 4 is a conceptual view for explaining a first payment type among a plurality of payment types according to the present invention. FIG. 5 is a conceptual view for explaining a second payment type among a plurality of payment types according to the present invention. FIGS. 6 to 8 are conceptual views for explaining a payment method according to the present invention, and FIG. 9 is a conceptual view for explaining a payment history of a user account according to the present invention.

Firstly, in an electronic payment method according to the present invention, a selection information receiving process (S310) may be performed of receiving selection information for selecting a specific payment type among a plurality of different payment types related to digital currency. Such selection information may be received with respect to a user account.

More specifically, the selection information may be received through a page of a specific application (e.g., a WebComics contents providing application) associated with the electronic payment system 100 of the present invention, or a specific webpage (e.g., a WebComics contents providing webpage).

The controller 130 may provide a “charging guide page” for inducing purchase (or charging) of digital currency, onto the user's electronic device 200, in order for digital currency to be purchased through an automatic payment method. Such a charging guide page may be provided only under a preset condition. For instance, a “charging guide page” for inducing charging of digital currency may be provided only when a user firstly executes a specific application or when a user firstly accesses a specific web page.

The charging guide page may be referred to as an “automatic payment registration page” for setting a payment type related to digital currency, or a “charging registration page,” etc.

A user may select a specific payment type among a plurality of different payment types related to an automatic payment method, through a charging registration page.

When a request to provide (connect to or access) a “charging registration page” is received from the user's electronic device 200, the controller 130 may provide the “charging registration page” onto the user's electronic device 200.

The controller 130 may provide information related to the charging registration page to the user's electronic device 200, such that the charging registration page is provided to the user's electronic device 200.

The user's request for providing the charging registration page may be performed through various paths. For instance, the charging registration page may be provided based on a selection for one region among a “charging guide page” outputted onto the electronic device 200. The one region may be a region where a function icon related to provision of the charging registration page has been output.

The controller 130 may output information on a plurality of different payment types related to digital currency, onto the “charging registration page.” In the present invention, through such information, a plurality of different payment types are introduced to a user so that the user may select a specific payment type corresponding to his or her contents consumption pattern, etc.

In the present invention, a plurality of different payment types may be related to different payment conditions. The controller 130 may control an electronic payment process to be started when a payment event which satisfies a payment condition matched with each of a plurality of payment types occurs at the user account.

A plurality of payment types will be explained in more detail. A plurality of payment types may be related to different payment conditions. That is, a plurality of payment types may mean specifying automatic payments with respect to a user account on the basis of specific payments.

The plurality of payment types may be categorized based on various payment conditions. For instance, the plurality of payment types may include i) a first payment type matched with a payment condition related to the amount of digital currency, and ii) a second payment type matched with a payment condition related to a reference date (a specific date, a payment date, etc.).

In the case of the first payment type among the plurality of payment types, a payment process may be started with respect to digital currency retained at the user account. For instance, in the case of the first payment type, the controller 130 may start a payment process when the amount of digital currency retained at the user account does not satisfy a preset reference amount.

Further, in the case of the second payment type, a payment process may be started based on a reference date selected from the user account. In this case, the controller 130 may start a payment process with respect to the user account on each reference date.

In the present invention, a selection for an automatic payment process through a payment type may be received from the user.

As shown in FIGS. 4 and 5, such a user's selection may be received through charging registration pages 410, 510. The charging registration pages 410, 510 may include graphic objects 420, 520 for selecting at least one of a plurality of payment types. The user may specify his or her desired payment type through a selection for a graphic object.

Next, in the present invention, a payment condition registration process may be performed (S320). Such a payment condition registration process may be performed through selection information generated after selecting a specific payment type among a plurality of payment types by the user, and then inputting (or selecting) information on a payment condition related to the specific payment type.

In the present invention, a payment condition is a basis by which a payment event which starts a payment process is generated, and may be different according to a payment type as aforementioned.

When a specific payment type is selected, the controller 130 may receive information on a payment condition for the specific payment type and amount information of digital currency to be purchased.

Here, the selection information may include at least one of payment condition information and amount information. The controller 130 may register a payment condition corresponding to a specific payment type to a user account, by using selection information received from the user account.

More specifically, the controller 130 may receive payment condition information and amount information corresponding to a payment type, based on a user's selection for a specific payment type among a plurality of payment types. The amount information may mean information which specifies the purchase amount for digital currency.

For instance, as shown in FIG. 4, when the user selects for a first payment type, the controller 130 may receive, from the user account, i) information 430 on the minimum amount of digital currency which is a condition (or a payment condition) to start a payment process, and ii) information 440 on the amount of digital currency to be purchased through a payment process.

As shown in FIG. 4(a), when a graphic object 420 corresponding to a first payment type is selected from the user account and selection information is received, the controller 130 may provide, onto the user's electronic device 200, a page corresponding to a graphic user interface (GUI) for inputting a minimum amount 430 (reference amount or reference cookies) of digital currency corresponding to a condition to start a payment process, and ii) an amount 440 of digital currency (e.g., cookies) to be purchased (or to be charged).

When the number of units of digital currency retained by a user is less than a predetermined number, the user may input selection information for charging a predetermined number of units of digital currency, through a page. Selection information selected from the user's electronic device 200 may be transmitted to the payment system 100. For instance, when the number of cookies (a name of digital currency) retained at the user is less than 50, in the case of charging 100 cookies, the user may select a minimum amount of digital currency as 50 and may select a purchase amount of digital currency as 100. Such selection information may be transmitted to the payment system 100 of the present invention. The payment system 100 of the present invention may provide a user environment which allows a user to freely change an amount of digital currency. As shown in FIG. 4(b), a drop-down type of selection environment may be provided. A user may freely select the amount of digital currency as 20, 30, 50, 100, 300, etc. through a drop-down type of selection environment. A drop-down type of list may include items for selecting the amount of digital currency.

An amount unit of chargeable digital currency may be preset. The controller 130 may provide the user with information on a plurality of amount units (20, 30, 50, etc.), and may be provided with an amount unit selected from the user.

The controller 130 may differently recommend information on a minimum amount 430 (reference amount or reference cookies) of digital currency corresponding to a condition to start a payment process, according to an amount of digital currency retained at the user account. The controller 130 may recommend information on a minimum amount of digital currency to the user at a drop-down type of environment, and a recommended amount for the user may be changed according to an amount of digital currency retained at the user account.

Referring to FIG. 4(a), the controller 130 may set information on a minimum amount of digital currency for starting a payment process, to be larger than an amount of digital currency currently retained at the user account. In this case, among a plurality of amount units, the controller 130 may select an amount unit greater than a current amount of digital currency retained at the user account, as a recommendation amount. Also, if there is a plurality of amount units greater than the current amount of digital currency retained at the user account, the controller 130 may select a minimum amount unit among the plurality of amount units as a recommendation amount.

For instance, in a case where a user has 45 units of digital currency and there are amount units of “20, 30, 50 and 100”, the controller 130 may select a minimum amount (amount unit) of digital currency recommended to a corresponding user account, between 50 and 100, and the controller 130 may select the minimum amount unit, 50 as a recommendation amount. In this case, information on the recommendation amount may be output as minimum amount 430 of FIG. 4.

Under this configuration, when an automatic payment is registered at the user account, an electronic payment process may be immediately started by controlling an amount of digital currency retained at the user account to satisfy a payment condition.

The controller 130 may control an amount unit which is less than the amount of digital currency retained at a user account, so that it is not included on a drop-down type of list.

A minimum amount unit recommended to a user account may be variously changed in a manner besides the aforementioned methods.

As another example, as shown in FIG. 5, based on a user's selection for a second payment type, the controller 130 may receive, from a user account, i) information 530 on a reference date (a specific date, a payment execution date, a payment date, etc.) corresponding to a payment process starting condition (or payment condition), and ii) information 540 on an amount of digital currency to be purchased through a payment process.

As shown in FIG. 5, when a graphic object 520 corresponding to a second payment type is selected from the user account and selection information is received, the controller 130 may provide, onto the user's electronic device 200, a page corresponding to a graphic user interface (GUI) for inputting a reference date 530 corresponding to a condition to start a payment process, and ii) an amount 540 of digital currency (e.g., cookies) to be purchased (or to be charged) on the reference date.

A user may input selection information for charging a predetermined number of units of digital currency on each reference date through a page. The selection information selected from the user's electronic device 200 may be transmitted to the payment system 100. For instance, if the user wishes to charge 100 cookies on the 1st day of each month, the user may select a reference date (or a specific date) as the 1st day, and may select a purchase amount of digital currency as 100. Such selection information may be transmitted to the payment system 100 of the present invention.

As shown in FIGS. 4 and 5, the controller 130 may provide a user with information 450, 550 related to inducement of registration of an automatic payment in order to induce an automatic payment registration more positively.

The information 450, 550 may include at least one of information on benefits of digital currency provided to the user, and information on benefits of contents usage, based on an automatic payment (i.e., automatic charging) of digital currency.

As aforementioned, in a case where selection information related to a payment condition is received from the user (through the user account or the user's electronic device), the controller 130 may register a payment condition corresponding to a specific payment type to the user account, by using the selection information.

The controller 130 may register a different payment condition to a user account according to selection information. Here, “registration” may mean storage of selection information by being matched with a user account.

Meanwhile, information registered to a user account may include at least one of i) information on a payment type, ii) detailed information on a payment condition according to a payment type (e.g., a minimum amount of digital currency which allows a payment process to be started, information on a reference date when a payment process is started, etc.), and iii) information on an amount (or amount information) of digital currency purchased through a payment process. Information registered to a user account may be expressed as information related to a payment condition such as “information about a payment condition” or “payment condition information”.

The controller 130 registers a payment condition to a user account, and thus may control an electronic payment process for the user account to be started as a payment event which satisfies the payment condition at the user account. In the present invention, this will be referred to as “automatic payment registration (or automatic charging registration).”

Referring to FIG. 6(a), an example to register a payment condition for a first payment type will be explained. The controller 130 may register, to a user account, i) information on a payment type 613 (e.g., information on a first payment type) received from the user account, ii) information on a payment condition 611 (information on a minimum amount of digital currency which allows a payment process to be started, e.g., 30) and iii) information on a purchase amount 612 (information on a purchase amount of digital currency, e.g., 100). As shown, the registration information may be provided to the user's electronic device for the user to check.

Further, referring to FIG. 6(b), an example to register a payment condition for a second payment type will be explained. The controller 130 may register, to a user account, i) information on a payment type 623 (e.g., information on a second payment type) received from the user account, ii) information on a payment condition 621 (information on a reference date when a payment process is started, e.g., the 1st day of the month) and iii) information on a purchase amount 622 (information on a purchase amount of digital currency, e.g., 100). As shown, the registration information may be provided to the user's electronic device 200 for the user to check.

In this manner, after a payment condition is registered to the user account, a payment event related to the payment condition may be generated at the user account (S330).

The controller 130 may monitor whether a payment event which satisfies the payment condition registered to the user account is generated at the user account. Based on the payment condition according to the payment type registered to the user account, the controller 130 may continuously check an amount of digital currency retained at the user account, or may determine whether a current date is consistent with a reference date (specific date) registered to the user account.

More specifically, in a case where the payment condition registered to the user account is related to a first payment type, when an amount of digital currency retained at the user account is less than (or equal to or less than) a reference amount (or a minimum amount) corresponding to the payment condition, the controller 130 may determine that a payment event has occurred. In contrast, when an amount of digital currency retained at the user account is more than (or exceeds) a reference amount (or a minimum amount) corresponding to the payment condition, the controller 130 may determine that a payment event has not occurred.

Further, in a case where the payment condition registered to the user account is a payment condition related to a second payment type, when a current date is a pre-registered reference date, the controller 130 may determine that a payment event has occurred. In contrast, when a current date is not a pre-registered reference date, the controller 130 may determine that a payment event has not occurred.

In this manner, the controller 130 may monitor whether a payment event according to a pre-registered payment condition has occurred at the user account.

In a case where a payment event occurs at the user account, an electronic payment process for purchasing digital currency may be started (S340).

In response to the occurrence of a payment event, the controller 130 may start an electronic payment process to purchase digital currency, for the user account.

Here, the “start of an electronic payment process” may mean an action (behavior) or a procedure to begin an electronic payment process. That is, the start of an electronic payment process is a concept differentiated from “completion of an electronic payment process,” and may mean beginning of an electronic payment process. When an electronic payment process is started, an electronic payment process for purchasing digital currency by using a payment means registered to the user account may be performed. The completion of an electronic payment process may mean a completed state of purchase of digital currency.

In a case where an electronic payment process is started, the controller 130 may perform an electronic payment for purchase of a pre-determined number of units of digital currency included in a payment condition pre-registered to the user account.

In the present invention, an electronic payment process is performed in various manners, and a price for a purchase amount of digital currency may be paid by using a payment means pre-registered to the user account. For instance, when a pre-registered payment means is an account transfer or a credit card, the controller 130 may control the communication unit 110 to communicate with a financial institution (bank or credit card company) server. The controller 130 may control the communication unit 110 to request a financial institution to pay for a price corresponding to a specific purchase amount of digital currency, from a bank account or a credit card associated with the user account. However, the aforementioned procedure is a mere example, and a procedure firstly performed for an electronic payment process is not limited to this.

The price paid through an electronic payment process may correspond to amount information. Here, the amount information is information included in a payment condition pre-registered to a user account, and may be a price corresponding to a purchase amount of digital currency. That is, in the present invention, a price to be paid may mean a price corresponding to a purchase amount of digital currency included in a payment condition pre-registered to the user account. The price to be paid may mean a price corresponding to an amount of digital currency to be charged by the user.

A “completion of an electronic payment process” may mean a paid state of a price to the payment system 100 of the present invention through an electronic payment. A case where the price has been normally paid to the payment system 100 of the present invention will be referred to as “completion of an electronic payment process.”

When an electronic payment process is completed, the controller 130 may provide digital currency having a predetermined purchase amount to the user account. The controller 130 may provide an amount corresponding to purchased digital currency to the user account. For instance, in a case where a purchase of 100 units of digital currency has been set to a payment condition, the controller 130 may start and complete an electronic payment process for a price corresponding to 100 units of digital currency, and may provide 100 units of digital currency to the user account.

The controller 130 may continuously monitor the occurrence of a payment event after an electronic payment for the user account has been completed. That is, the controller 130 may monitor the user account to which an automatic payment method has been registered, thereby starting a payment process whenever an event which satisfies a payment condition occurs at the user account.

The controller 130 may start an electronic payment process whenever a payment event occurs at the user account, according to a monitoring result. Thus, the user may be automatically provided with a purchase service of digital currency whenever a payment condition is satisfied.

Based on completion of an electronic payment process, the controller 130 may supply digital currency to the user account, and then monitor whether a next payment event has been generated. When a payment event occurs, the controller 130 may continuously monitor whether a payment event has been generated, instead of stopping monitoring.

Thus, the controller 130 may supply digital currency corresponding to amount information pre-registered to the user account whenever an electronic payment process is normally completed at the user account. That is, the controller 130 may provide digital currency to the user account whenever a payment event occurs and an electronic payment process is completed. In this specification, this will be referred to as “automatic payment (or automatic charging)”.

For instance, when selection information about a received payment type (e.g., a first payment type), a payment condition (e.g., a minimum amount of 50) and amount information (e.g., purchase of 100 units of digital currency) are received from the user account, the controller 130 may start an electronic payment process for a price corresponding to 100 units of digital currency whenever the number of units of digital currency retained at the user account is less than 50 (e.g., 48). When the electronic payment process for the price corresponding to 100 units of digital currency is completed, the controller 130 may provide 100 units of digital currency to the user account.

As another example, when selection information about a received payment type (e.g., a second payment type), a payment condition (e.g., a reference date, the 1^{st} day) and amount information (e.g., purchase of 100 units of digital currency) are received from the user account, the controller 130 may start an electronic payment process for the price corresponding to 100 units of digital currency whenever a current date corresponds to the 1st day (e.g., the 1st day of February, the 1st day of March, etc.). When the electronic payment process for the price corresponding to 100 units of digital currency is completed, the controller 130 may provide 100 units of digital currency to the user account.

In the above description, an explanation has been given of a process of automatically performing an electronic payment process according to a specific payment type, and a process of supplying digital currency to the user account.

In accordance with another embodiment of the present invention, the payment method and system 100 may supply “bonus digital currency” to a user account, separately from digital currency supplied in correspondence to the user's payment for the price to be paid (hereinafter, will be referred to purchased digital currency). The “bonus digital currency” provided in the payment method and system according to the present invention will be explained in more detail.

When an electronic payment process is completed, the controller 130 may supply bonus digital currency having an additional amount to the user account, together with purchased digital currency. The bonus digital currency may be supplied whenever purchased digital currency is generated, or may be supplied under a specific condition. A situation to supply bonus digital currency may be changed variously.

For instance, the controller 130 may supply bonus digital currency based on the number of times of completion of an electronic payment process for purchasing digital currency. This is in order to maintain automatic payment for the user's continuous purchase of digital currency. That is, in order to positively induce the user's automatic payment registration, the controller 130 may provide bonus digital currency to the user account based on the occurrence of a payment event which satisfies a payment condition, and based on completion of an electronic payment process. An amount of bonus digital currency supplied to the user account may be set variously.

Whether to supply bonus digital currency to the user account and a supply amount may be determined based on at least one of i) an amount of digital currency to be purchased, ii) a completion frequency (the number of times) of an electronic payment process, and iii) whether purchase of digital currency has been firstly performed. For instance, when an amount of digital currency to be purchased is great, a supply amount of bonus digital currency may be increased. Further, when a purchase frequency of digital currency is great, a frequency of bonus digital currency may be increased.

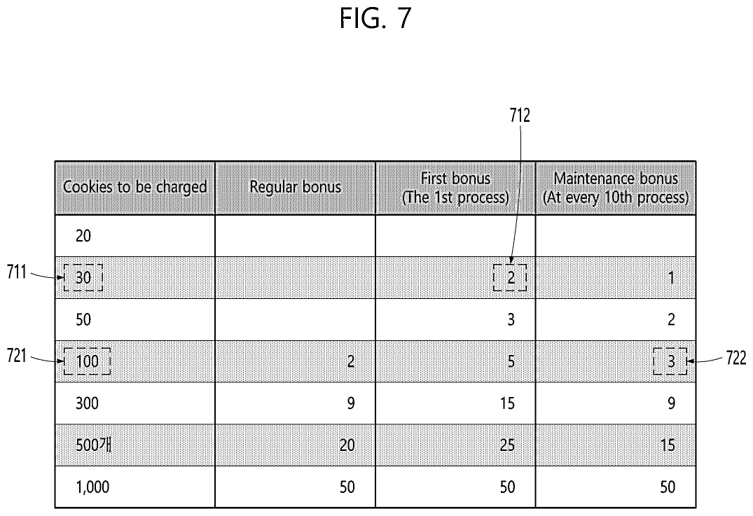

Information on at least one of whether to supply bonus digital currency and a supply amount may be stored in the storage unit 120. For instance, as shown in FIG. 7, amount information of bonus digital currency may be stored in the storage unit 120, in a matching manner with a purchase amount of digital currency (e.g., an amount of cookies to be charged). Further, additional amount information of bonus digital currency may be stored in the storage unit 120, in a matching manner with a completion frequency of an electronic payment process.

As shown in FIG. 7, information related to supply of bonus digital currency may be referred to as information on “a bonus digital currency supplying condition,” etc. Meanwhile, the bonus digital currency supplying condition may be properly changed according to necessity, under control of a manager or the controller 130.

The controller 130 may supply bonus digital currency to the user account according to the bonus digital currency supplying condition stored in the storage unit 120, as much as an amount corresponding to the condition. For instance, to the user account to which an automatic payment for purchasing 30 units of digital currency (refer to 711) has been registered, i) 2 units of bonus digital currency (refer to 712) may be supplied when a first electronic payment process is completed, and ii) 1 unit of bonus digital currency may be supplied when every 10^{th} electronic payment process is completed (that is, when an electronic payment process of the number of times corresponding to multiples of 10 is completed).

As another example, to a user account to which an automatic payment for purchasing 100 units of digital currency (refer to 721) has been registered, i) 2 units of bonus digital currency may be supplied whenever an electronic payment process is completed, ii) 5 units of bonus digital currency may be supplied when a first electronic payment process is completed, and ii) 3 units of bonus digital currency (refer to 722) may be supplied when every 10th electronic payment process is completed (that is, an electronic payment process of the number of times corresponding to multiples of 10 is completed).

For this, the controller 130 may count the number of times that an electronic payment process has been completed. In this case, the controller 130 may perform counting with respect to the number of times that an electronic payment process by an automatic payment method has been completed. That is, the controller 130 may perform counting with respect to the number of times that an electronic payment process which had been started as a payment event which satisfies a payment condition has been completed.

Here, the controller 130 may count the number of times of an electronic payment process performed with a process for receiving selection information, a payment condition and amount information from a user account, as one. Then, the controller 130 may sequentially count the number of times of electronic payment processes subsequently performed as payment events which satisfy payment conditions registered to a user account occur. That is, the controller 130 may count an electronic payment process performed with a process for receiving selection information, a payment condition and amount information from a user account, as a first process, and may count an electronic payment process subsequently completed as a payment condition event, as a second process.

Further, the controller 130 may count the number of times of an electronic payment process first performed as a payment event which satisfies a payment condition as one. That is, the controller 130 may sequentially count the number of times of electronic payment processes completed as events which satisfy payment conditions, from one.

Further, the controller 130 may store a counting result in the storage unit 120 in an associating manner with a user account and a payment history. When an electronic payment process is completed, the controller 130 may check a payment history stored in the storage unit 120 in an associating manner with a user account. If there is no payment history stored in the storage unit 120 in an associating manner with a user account, the controller 130 may count the number of times of an electronic payment process performed before checking a payment history, as one.

In the present invention, in order to provide a user benefit for automatic payment type of registration, bonus digital currency may be additionally supplied to a user account when the number of times of an electronic payment process performed in an associated manner with the user account is one. This may be referred to as a benefit such as “subscription celebration bonus,” etc. The controller 130 may supply bonus digital currency to a user account as much as an additional amount of the bonus digital currency stored in the storage unit 120 in an associated manner with the first payment process.

The controller 130 may supply bonus digital currency to a user account based on information on a bonus digital currency supplying condition stored in the storage unit 120.

The controller 130 may supply bonus digital currency to a user account with a differentiated additional amount according to a purchase amount of digital currency. The controller 130 may supply bonus digital currency of a larger additional amount to a user account when a price to be paid is higher. That is, in the payment method and system of the present invention, a larger reward may be supplied to a user when a purchase amount of digital currency is larger.

Further, the controller 130 may supply bonus digital currency to a user account with a differentiated additional amount, according to the number of times of a completed electronic payment process. The controller 130 may supply bonus digital currency of a larger amount to a user account when the number of times of a completed electronic payment process is larger. For instance, a larger number of units of bonus digital currency may be supplied to a user account when a 20th electronic payment process is completed than when a 10th electronic payment process is completed. That is, in the payment method and system of the present invention, a larger reward may be supplied to a user when the number of times of payment is larger.

The controller 130 may set an available period (usage period) of purchase digital currency to be different from that of bonus digital currency. In the case of purchase digital currency, an available period may not be set. In the case of bonus digital currency, an available period may be set for the bonus digital currency to be usable only for a specific period of time.

Alternatively, in the case of purchase digital currency, an available period may be set. In this case, the controller 130 may set an available period of bonus digital currency to be relatively shorter than that of purchase digital currency.

Further, in the case of digital currency having a setting of an available period, the controller 130 may set a starting date of the available period as a date when digital currency has been supplied to a user account.

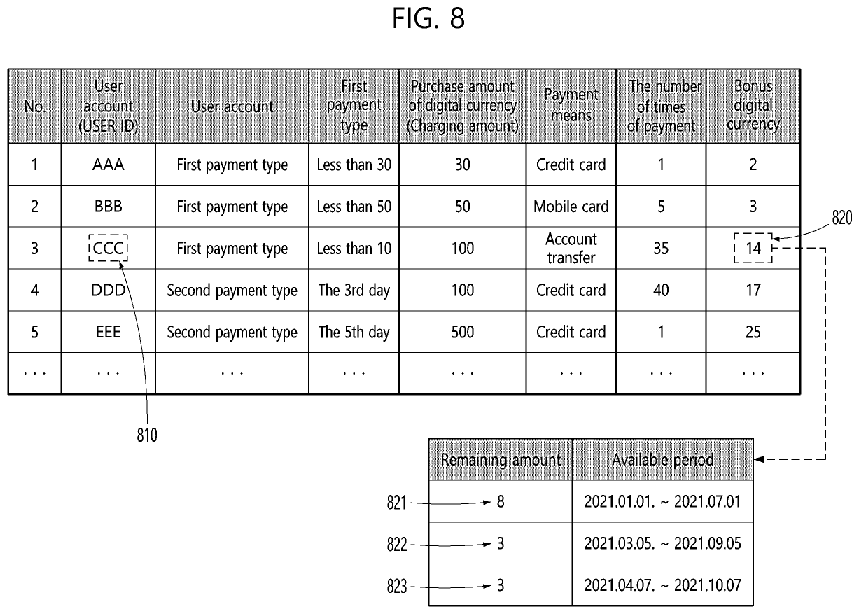

For instance, as shown in FIG. 8, a user account, “CCC” 810 has a total of 14 units of bonus digital currency 820. The 14 units of bonus digital currency of the “CCC” user account (user ID) consist of i) 8 units of bonus digital currency 821 supplied on Jan. 1, 2021, ii) 3 units of bonus digital currency 822 supplied on Mar. 5, 2021, and iii) 3 units of bonus digital currency 823 supplied on Apr. 7, 2021. Each of the bonus digital currency has an available period of 6 months. Thus, an expiration date of each of the bonus digital currency retained by the “CCC” user account may be differently set. That is, in the case of i) 8 units of bonus digital currency 821 being supplied on Jan. 1, 2021, an expiration date may be Jul. 1, 2021. In the case of ii) 3 units of bonus digital currency 822 being supplied on Mar. 5, 2021, an expiration date may be Sep. 5, 2021, in the case of iii) 3 units of bonus digital currency 823 being supplied on Apr. 7, 2021, an expiration date may be Oct. 7, 2021.

Meanwhile, when a set available period of bonus digital currency lapses, the controller 130 may control the bonus digital currency having its available period lapsed to expire. In this case, the digital currency to be expired may be withdrawn or subtracted from the user account.

Here, the controller 130 may inform the user account of an expiration schedule of the bonus digital currency, before the expiration date of each bonus digital currency by a preset time period.

So far, a description has been provided of purchase digital currency and bonus digital currency supplied to a user account, based on completion of an electronic payment process. Hereinafter, a payment history stored in the storage unit 120 in an associated manner with a user account will be explained in more detail with reference to the drawings. FIG. 9 is a conceptual view for explaining a payment history of a user account according to the present invention.

The controller 130 may store a user's payment history in the storage unit 120 by associating with a user account. The payment history may mean information related to purchase of digital currency. For instance, the payment history may include at least one of information on i) a payment method for digital currency (e.g., a first payment method (a one-time payment method) or a second payment method (an automatic payment method), ii) in the case of the second payment method, whether a first payment type (a payment type performed on the basis of a holding amount of digital currency) or a second payment type (a payment type performed on the basis of a reference date), iii) the number of units of digital currency purchased at a user account (accumulated purchase amount), iv) a purchase amount of digital currency purchased whenever a payment event occurs, v) an amount of digital currency owned at present, vi) the number of bonus digital currency supplied (accumulated supply amount), vii) an available period of bonus digital currency, viii) an amount of bonus digital currency owned at present, ix) purchase cancellation of digital currency, x) change of a payment method, a payment type, etc., and xi) an automatic payment stop, release, etc.

Such payment history information may be provided to a user. As shown in FIG. 9, the controller 130 may provide at least a part of information included in the aforementioned payment history, onto the user's electronic device 200. As shown in FIG. 9, the controller 130 may provide a payment history 920 related to digital currency, onto a payment history page 910. Through the payment history page 910, a user may be provided with i) the number of units of digital currency owned at present (921), ii) a purchase (or charging) date of digital currency (922), iii) the number of purchase (or charging) of digital currency (923), iv) a price to be paid (924), v) whether purchase of digital currency has been canceled (925), etc.

Although not shown, the controller 130 may expose a digital currency purchase cancellation button to the “payment history page” together with a payment history.

The controller 130 may expose a purchase cancellation button only with respect to digital currency having its purchase cancellation available. That is, whether cancellation is allowable or unallowable may be differently set according to a lapse period on the basis of a purchase date of digital currency or according to a used state or a non-used state.

For instance, the controller 130 may not expose a purchase cancellation button when i) a preset time period (e.g., 7 days) has lapsed on the basis of a purchase date of digital currency, and ii) when digital currency has been used (that is, consumed to view contents) although a preset time period (e.g., 7 days) has not lapsed on the basis of a purchase date of the digital currency.

If the purchase cancellation button exposed onto the electronic device 200 is selected by a user, a request to cancel purchase of digital currency may be transmitted to the payment system 100 of the present invention. In the case of receiving the request to cancel purchase of digital currency, the controller 130 may start an electronic payment process for purchase cancellation.

As aforementioned, an electronic payment of the present invention may be categorized into i) a payment performed by a user's request, like a one-time payment method according to a first payment method, and ii) a payment performed as a payment event which satisfies a preset payment condition, like an automatic payment method according to a second payment method. The payment performed as a payment event which satisfies a payment condition means an “automatic payment” explained so far.

Even in a state of “automatic payment registration” to a user account, the controller 130 may perform a one-time payment (or an anytime payment) according to a user's request. For instance, when an automatic payment has not been performed because an electronic payment means pre-registered to a user account is not available, or when digital currency charged through an automatic payment has been used-up, a one-time payment may be made at any time.

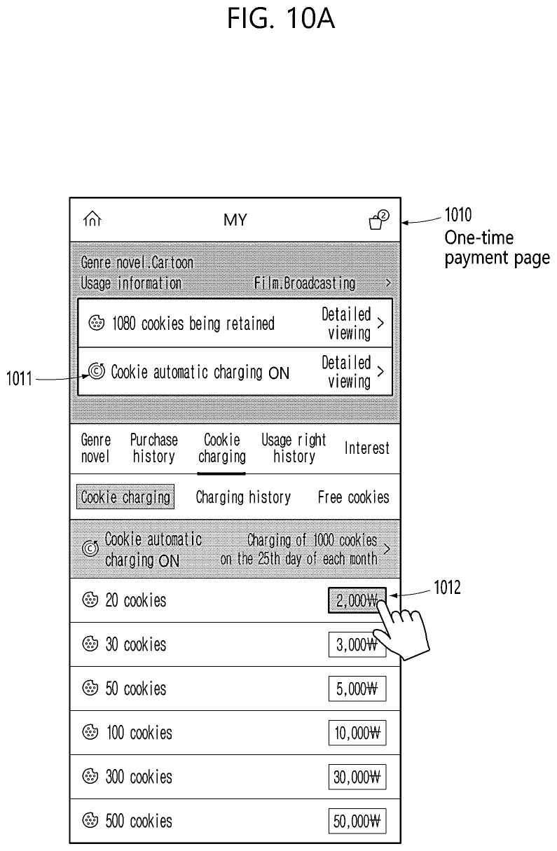

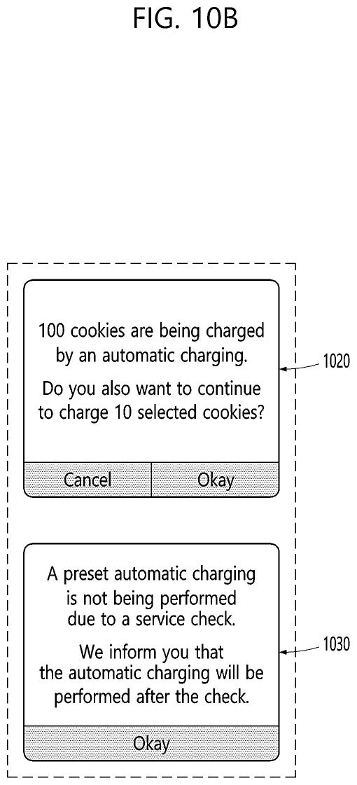

Hereinafter, “a one-time payment” will be explained in more detail with reference to the attached drawings. FIGS. 10A and 10b are conceptual views for explaining a general payment method (a one-time payment method) according to the present invention.

The “one-time payment” explained in the present invention may mean a case where a payment is immediately performed when there is a request of a user (or a consumer) and an additional payment is not performed thereafter.

The controller 130 may receive a request for a one-time payment from a user account even when there is a payment condition registered to a user account. However, the payment system 100 of the present invention provides a means for protecting a user from an error or indiscreet payment of the user.

In the case of receiving a request for a one-time payment from a user account, the controller 130 may determine whether there exists a history related to an automatic payment pre-registered to the user account (whether an automatic payment has been registered or not, an automatic payment condition, etc.). If there does not exist a history related to an automatic payment registered to the user account, the controller 130 may determine the user account as a user who has not registered an automatic payment (or automatic charging). In this case, the controller 130 may transmit information which guides an automatic payment (or automatic charging) to the user account, before performing an electronic payment process with respect to the request for a one-time payment received from the user account.

Further, if there exists a history related to an automatic payment registered to the user account, the controller 130 may determine the user account as a user who has registered an automatic payment (or automatic charging). In this case, the controller 130 may transmit information related to an automatic payment registered to the user account (e.g., a payment condition, amount information, etc.) to the user's electronic device.

The user may request for a one-time payment to the payment system 100 of the present invention, while forgetting that an automatic payment has been registered to his or her account. In this case, the user may be provided with a payment condition, amount information, etc. outputted to the electronic device 200, and may determine whether to continuously perform a one-time payment.

As aforementioned, in a case where there exists a payment condition registered to a user account but an electronic payment process has not started (or an execution of an electronic payment process has failed) due to a communication error, etc. of the payment system 100 of the present invention or a financial institution server, the controller 130 may provide information on the case to the user account.

The user may intend to perform a one-time payment for digital currency, because the digital currency has not been charged, in spite of the occurrence of a payment event which satisfies a payment condition. In this case, the payment system 100 of the present invention may prevent the user from performing a repetitious payment by informing the user of a systematic error.

For instance, as shown in FIG. 10A, the controller 130 may receive a user's request for an electronic payment of a price (e.g., 2000 won) 1012 corresponding to digital currency (e.g., 20 cookies), through a “one-time payment page” 1010. To the one-time payment page 1010, information 1011 on the user's automatic payment history may be exposed together. Under this configuration, the user may determine whether the need to purchase digital currency can be solved, through an automatic charging, before a one-time payment is performed.

In the case of receiving a request for a one-time payment from the user account through the communication unit 110, the controller 130 may check whether there exists an automatic payment history pre-registered to the user account. If there exists an automatic payment history pre-registered to the user account, the controller 130 may expose information on the history onto the electronic device 200 (refer to FIG. 10B).

As shown in FIG. 10B, in a case where an automatic charging has not been completed due to a service check of the system or a system delay, although an automatic payment process is being performed, the controller 130 may output guide information 1020 to the electronic device 200. The user may recognize that the preset automatic charging is not being performed due to a service check of the system, a system delay, etc. In the case of receiving a request for a one-time electronic payment for digital currency despite the provision of such message, the controller 130 may start and complete a one-time electronic payment process. Further, the controller 130 may continuously perform an electronic payment process according to an automatic payment function being checked or delayed. Here, in a case where the service check or delay is solved, the electronic payment process according to the automatic payment function is completed. Thus, digital currency purchased based on the automatic payment function may be supplied to the user account.

The user may check a guide message exposed to the electronic device 200, and may determine whether to continuously perform a one-time payment. The user may cancel the one-time payment if the one-time payment has been erroneously performed. Further, the user may perform a one-time payment when additional digital currency is required besides digital currency automatically charged.

In a case where digital currency is not automatically charged due to a service check of the system at the user account, the controller 130 may output a guide message 1030 to the electronic device 200. The user may recognize that a preset automatic charging is not being performed due to a service check.

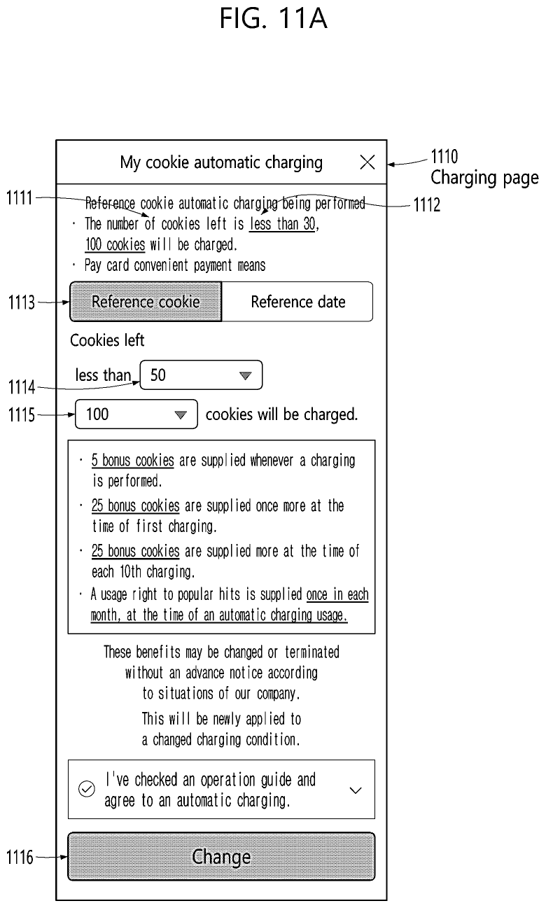

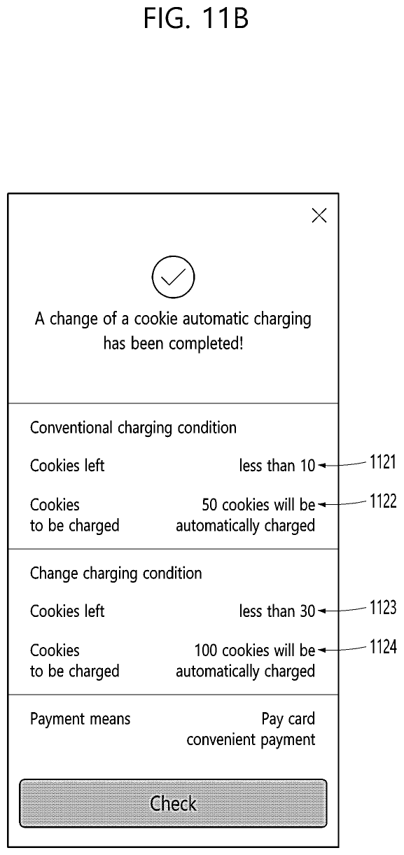

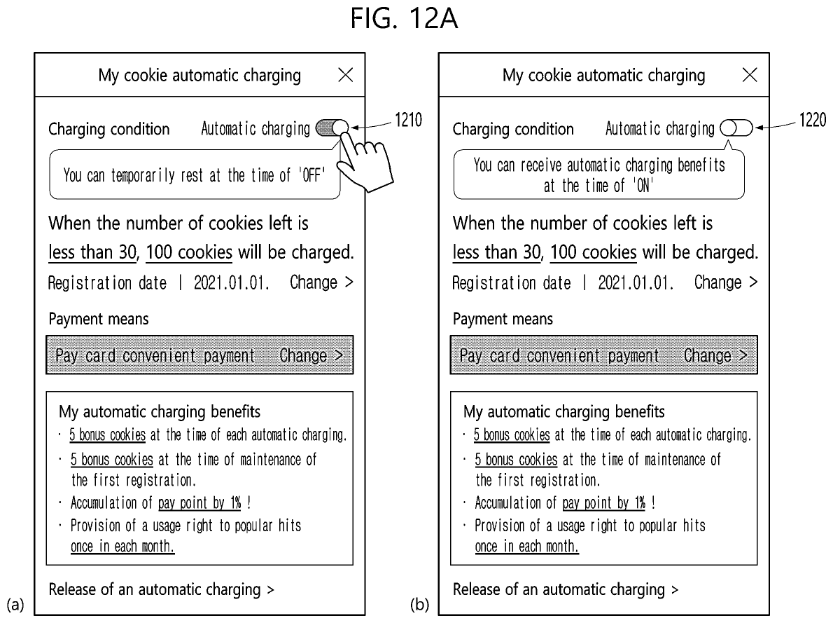

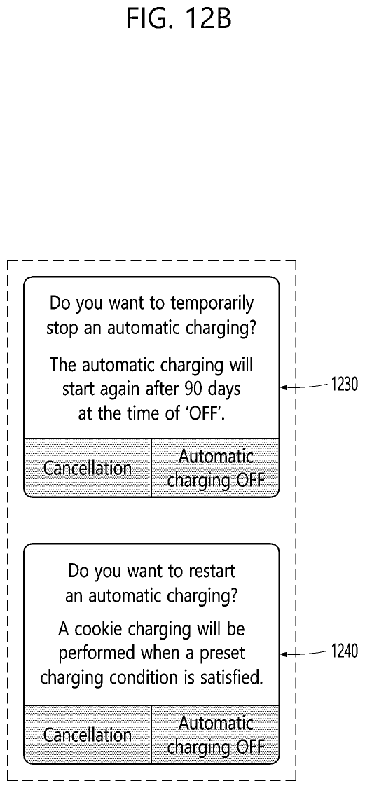

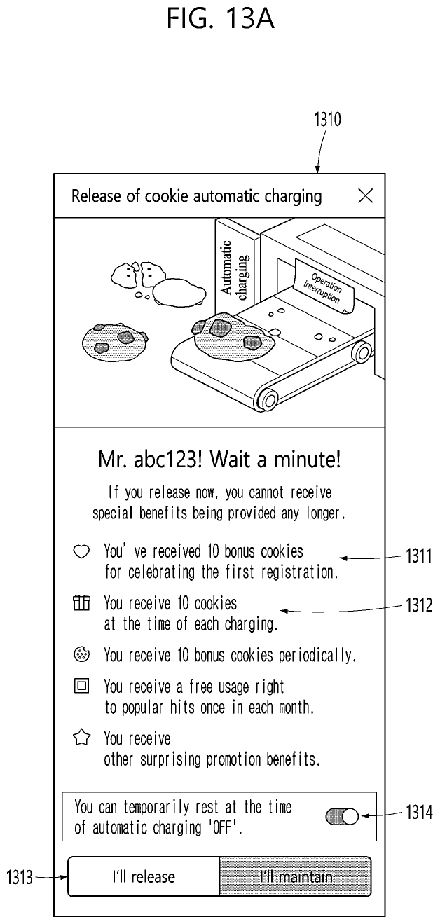

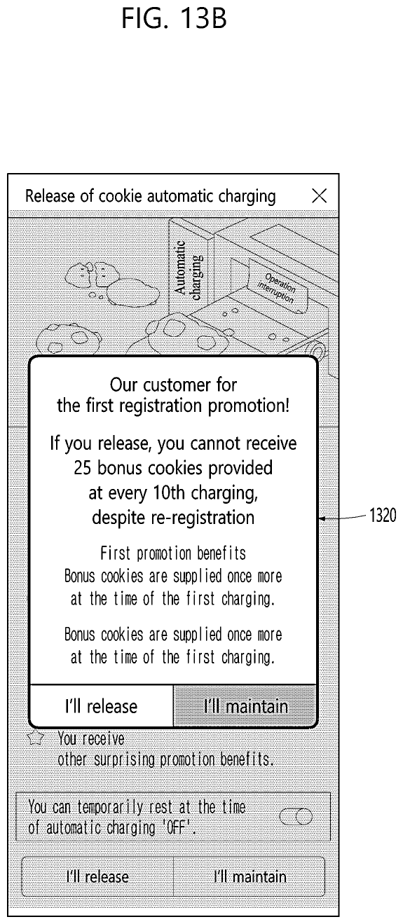

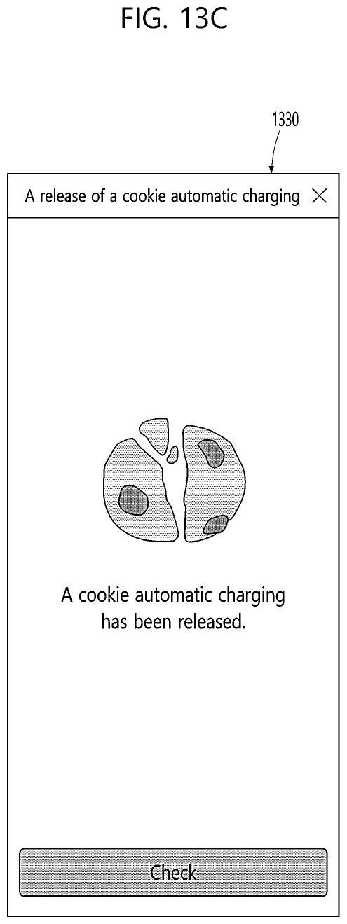

Hereinafter, i) a change of an automatic payment (or automatic charging) registered to a user account (that is, a change of a payment condition registered to a user account), ii) a stop thereof, and iii) a release thereof will be explained with reference to the attached drawings. FIGS. 11A and 11B are conceptual views for explaining a change of a payment condition according to the present invention. FIGS. 12A and 12B are conceptual views for explaining a method to stop an electronic payment according to the present invention, and FIGS. 13A to 13C are conceptual views for explaining a method to release an electronic payment according to the present invention.

Firstly, a change of a payment condition of an automatic payment will be explained. A change of a payment condition means a change of at least one of a payment condition for an automatic payment and a purchase amount of digital currency. Such a change may be performed based on a user's request. According to a usage degree of the digital currency, the user may increase or decrease a purchase amount of digital currency, and may increase or decrease a payment frequency.

Further, such a change may be proposed by the controller 130. The controller 130 may recommend an automatic payment method and a payment condition suitable to the user, by collecting and analyzing the user's usage pattern with respect to digital currency.

As shown in FIG. 11, the controller 130 may provide, onto the electronic device 200, a page for changing automatic payment information (hereinafter, will be referred to as a “changing page”) 1110. Onto the changing page 1110, the controller 130 may provide at least one of information on a specific payment type being currently used by the user (first payment type or second payment type), information on a payment condition, and information on an automatic payment means (e.g., specific credit card information).

The changing page 1110 may include thereon a graphic object 1111 for selecting a specific payment type, and input regions 1114, 1115 for inputting a payment condition according to the specific payment type. That is, the controller 130 may provide a graphic user interface for the user to change a specific payment type and a payment condition according to the specific payment type, onto the changing page 1110. Through the changing page 1110, the user may check information related to a current automatic payment, and may change a payment type or a payment condition according to the specific payment type.

The controller 130 may receive a request to change a specific payment type and a payment condition according to the specific payment type, from the electronic device 200, through the communication unit 110. The controller 130 may register information included in the received change request to the user account. The controller 130 may register a payment condition corresponding to a specific payment type included in the change request to the user account. As shown in FIG. 11B, the controller 130 may provide a payment condition before a change and a payment condition after a change, onto the electronic device 200.

For instance, as shown in FIG. 11A, the controller 130 may provide, onto the changing page 1110, information on i) an existing payment type (e.g., a first payment type, a type that an automatic payment is performed based on a holding amount of digital currency) registered to a specific user account, ii) an existing payment condition (e.g., a minimum amount of 30), and iii) an existing purchase amount (e.g., 100). On the changing page 1110, the user may check i) an existing payment type, ii) an existing payment condition and iii) a payment amount 1112, and may change a desired part. For instance, while i) a specific payment type (e.g., a first payment type) is maintained, the user may newly set ii) a payment condition corresponding to a specific payment type (e.g., a minimum amount of 50) and iii) a purchase amount (e.g., 100), and may press a change button 1116. In this case, the change information set by the user may be transmitted to the payment system 100 of the present invention.

Further, as shown in FIG. 11B, the controller 130 having received the change request from the user account may register again a specific payment type included in the change request and a payment condition corresponding thereto to the user account.

Meanwhile, although a payment condition is changed, the controller 130 may maintain a payment completion frequency (the number of times) counted before the payment condition is changed. That is, the controller 130 may count a completion frequency of an electronic payment process performed based on the changed payment condition, subsequently to a frequency (the number of times) counted before the payment condition is changed. In correspondence to the change of the payment condition, an amount of bonus digital currency supplied to the user account may be changed. This may be determined based on the aforementioned supply reference of bonus digital currency.

Meanwhile, the present invention may provide an automatic payment interruption (stop) function and a release function. In the present invention, the interruption means a temporary pause of an automatic payment (or automatic charging) function, and may be differentiated from a release to erase (or cancel) an automatic payment (or automatic charging) registered to a user account.

Temporarily stopping an automatic payment function may mean converting an automatic payment function from an active state into an inactive state. The controller 130 may prevent an automatic payment for purchase of digital currency from being performed at a user account, while an automatic payment function is in an inactive state. In this case, although a payment event which satisfies an automatic payment condition occurs at the user account, an automatic payment may not be performed.

More specifically, as shown in FIGS. 12A(a) and (b), the electronic payment system 100 may provide graphic objects 1210, 1220 (e.g., buttons) for selecting activation and inactivation of an automatic payment (or automatic charging) function on the electronic device 200. The user may determine an active state of an automatic payment (or automatic charging) through the buttons 1210, 1220 for selecting activation and inactivation of an automatic payment (or automatic charging) function.

The controller 130 may receive information which determines activation and inactivation of an automatic payment (or automatic charging) function, from the electronic device 200.

In a case where an automatic payment (or automatic charging) function registered to the user account is in an active state, the controller 130 may receive information which changes the automatic payment (or automatic charging) function into an inactive state, from the electronic device 200 (i.e., automatic payment interruption).

Further, in a case where an automatic payment (or automatic charging) function registered to the user account is in an inactive state, the controller 130 may receive information which changes the automatic payment (or automatic charging) function into an active state, from the electronic device 200 (i.e., automatic payment interruption release).

When a request to stop an automatic payment function (i.e., a request to stop an automatic payment or to release an automatic charging) is received from the user account, the controller 130 may store, in the storage unit 120, information on a payment history including the number of times of an electronic payment process which has been completed at the user account, and information on the request to stop an automatic payment function.

The controller 130 may not start a payment process for purchase of digital currency, even if a payment event which satisfies a payment condition registered to the user account occurs in relation to the user account. Especially, the controller 130 may not start a payment process for purchase of digital currency even if a payment event occurs, for a preset time period from a time when a request to stop a purchase function is received from the user account.

The controller 130 may release the stop of a purchase function at the user account, after a preset time period from the time when the request to stop a purchase function is received from the user account. That is, when a preset time period lapses, the controller 130 may change the automatic payment (or automatic charging) function of the user account into an active state. In this case, the controller 130 may re-monitor whether a payment event which satisfies a payment condition registered to the user account occurs, and may start an electronic payment process when a payment event occurs.

Here, the preset time period may be selected from the user, or may be set by the controller 130. When the preset time period is selected from the user, the controller 130 may restrict the preset time period from exceeding a predetermined time period. That is, when the preset time period selected from the user exceeds a predetermined time period, the controller 130 may stop a purchase function only for the predetermined time period.

For instance, as shown in FIG. 12A, a user may set an automatic payment (or automatic charging) function into an active state (ON) (refer to FIG. 12A(a)) or may set an automatic payment (or automatic charging) function into an inactive state (OFF) (refer to FIG. 12A(b)), through an automatic payment (or automatic charging) function setting button outputted onto the electronic device 200.

The controller 130 may receive a request to stop an automatic payment function with respect to digital currency, from the user account through the communication unit 110. As shown in FIG. 12B, the controller 130 which has received the request to stop an automatic payment function with respect to digital currency may output information (a guide message) 1230 for checking whether to stop a purchase function, onto the electronic device 200.

Further, the controller 130 may not start an electronic payment process at the user account for a preset time period (e.g., 90 days) from a time when a request to stop a purchase function is received.

After the preset time period (e.g., 90 days) from the time when the request to stop a purchase function is received, the controller 130 may output a message 1240 for checking whether to activate an automatic payment (or automatic charging) function onto the electronic device 200. Further, the controller 130 may activate an automatic payment (or automatic charging) function, and may monitor whether a payment event occurs at the user account.

In a case where an electronic payment process by an automatic payment is completed after an automatic payment function is converted into an active state from an inactive state, the controller 130 may count a frequency (the number of times) in a subsequent manner to a payment completion frequency counted before the automatic payment function becomes inactive. For instance, in a case where an electronic payment process by an automatic payment completed as an automatic payment function is converted into an active state from an inactive state, in a state that a payment completion frequency counted before the automatic payment function becomes inactive is 9, the controller 130 may count the number of times of the electronic payment as 10.

Meanwhile, the present invention may provide a function to release an automatic payment (or automatic charging). In the present invention, release means erasure of an automatic payment (or automatic charging) registered to a user account, and may be differentiated from interruption to temporarily stop an automatic payment (or automatic charging).

The controller 130 may provide a page 1310 for providing an automatic payment release function (hereinafter, will be referred to as “release page”) to the electronic device 200. The controller 130 may expose information related to the user account onto the release page 1310. The information related to a user account may include information 1311, 1312 on user's benefits already-provided due to an automatic payment function. As shown, the benefit information may include information on at least one of bonus digital currency already supplied to a user account, bonus digital currency which can be supplied when the user account maintains an automatic payment (or automatic charging) function, and a free usage right for contents.

The controller 130 may provide a graphic object 1314 for selecting activation or inactivation of an automatic payment (automatic charging) function onto one region of the “release page.” Under this configuration, the payment system 100 of the present invention may induce a user to select interruption of an automatic payment (automatic charging), not release of an automatic payment (automatic charging).

When a graphic object (function icon) 1313 for releasing positioned on one region of the “release page” is selected by a user, release request information may be transmitted to the electronic payment system 100 of the present invention.

When a release request is received from the electronic device 200, the controller 130 may provide information associated with the user account (e.g., benefit information 1320) to the electronic device 200, as shown in FIG. 13B. Under this configuration, the payment system 100 of the present invention may induce a user to maintain an automatic payment (or automatic charging) function, by re-informing benefit information to the user.

For instance, as shown in FIG. 13A, a user may be provided with benefits associated with the user account through the “release page” 1310. For instance, through the release page 1310, a user may be provided with benefit information such as an amount of digital currency (e.g., 10 cookies) already supplied through an automatic payment (automatic charging) registration, or an amount of digital currency (e.g., 10 cookies) supplied whenever an automatic payment (automatic charging) is performed.

When a user selects the release function icon (release button 1313) on the release page 1310, benefits associated with the user account may be provided onto the electronic device 200 in the form of a pop-up message 1320 as shown in FIG. 13B. For instance, information for preventing a user from releasing an automatic payment (automatic charging), such as “In case of release, you cannot receive any longer 25 bonus cookies provided at the time of every 10th payment despite re-registration” may be provided in the form of a pop-up message.

Meanwhile, in a case where a user releases an automatic payment (automatic charging) function despite benefits which can be provided while the automatic payment (automatic charging) is maintained, a page 1330 (see FIG. 13C) for checking the release may be provided onto the electronic device 200.

In a case where the user requests for an automatic payment registration again after the automatic payment is released, the controller 130 may continuously count the number of times to a payment completion frequency (the number of times) from before the automatic payment function is released. For instance, in a case where an electronic payment process completed as an automatic payment function is requested again, in a state that a payment completion frequency counted before the automatic payment function is released is 9, the controller 130 may count the number of times of the electronic payment as 10.

In a case where the user requests for an automatic payment registration again after the automatic payment is released, the controller 130 may newly count a completion frequency of an electronic process by an automatic payment function, from one. In this case, the user may be a re-registrant, and the controller 130 may supply bonus digital currency for celebrating rejoining, etc. to the user account corresponding to the re-registrant.

As aforementioned, in the payment method and system of the present invention, whenever a payment event related to payment of digital currency occurs, a payment for purchase of digital currency is started. This may allow a payment for digital currency to be continuously performed. As a result, as purchase of digital currency used to view contents is continuously performed, consumption of contents may be continuously performed.

Further, at the time of viewing contents, a user convenience in that he or she need not perform an electronic payment for purchase of digital currency every time may be enhanced. And the user may freely view contents by using digital currency owned at any time.

That is, in the payment method and system of the present invention, an electronic payment process is automatically started based on the occurrence of a payment event related to a payment condition. This may provide a user convenience in that he or she need not additionally perform an electronic payment. Further, through an electronic payment method for purchase of digital currency which allows contents viewing to be continuously performed, a contents provider may effectively induce contents consumption by a consumer and may ensure the consumer's continuous contents consumption. This may prevent the consumer from leaving.

Further, as the present invention provides various payment types and payment conditions, a user may design an electronic payment method suitable for his or her taste and situation.

The aforementioned present invention may be executed by one or more processors in a computer, and may be implemented as a program which can be stored in a computer-readable medium.

Further, the aforementioned present invention can be implemented as a computer-readable code or instruction word in a program-recorded medium. That is, the present invention may be provided in the form of a program.

The computer-readable medium includes all types of recording devices for storing data which can be read by a computer system. Examples of the computer-readable medium include a Hard Disk Drive (HDD), a Solid State Disk (SSD), a Silicon Disk Drive (SDD), ROM, RAM, CD-ROM, a magnetic tape, a floppy disk, an optical data storage device, etc.

Further, the computer-readable medium includes a storage unit which may be a server or a cloud storage unit to which an electronic device can access through communications. In this case, the computer may download a program of the present invention from the server or the cloud storage unit, through wired or wireless communications.

Further, in the present invention, the aforementioned computer is an electronic device where a processor, i.e., a Central Processing Unit (CPU) is mounted, and there is no limitation on the type of the computer.

The foregoing embodiments are merely exemplary and are not to be construed as limiting the present invention. The scope of the present invention should be determined by reasonable interpretations of the appended claims, and all changes and modifications that fall within the metes and bounds of the claims, or equivalents of such metes and bounds are therefore intended to be embraced by the appended claims.

1. An electronic payment method, performed by at least one processor, for purchase of digital currency used to view contents, comprising:
receiving selection information for selecting a specific payment type among a plurality of different payment types related to the digital currency, in relation to a user account;
registering a payment condition corresponding to the specific payment type to the user account by using the selection information; and
starting an electronic payment process to purchase the digital currency for the user account in response to an occurrence of a payment event related to the payment condition at the user account.

2. The method of claim 1, further comprising monitoring whether the payment event which satisfies the payment condition occurs at the user account,
wherein in the starting of the electronic payment process, the payment process is started whenever the payment event which satisfies the payment condition occurs at the user account as a monitoring result.

3. The method of claim 2, further comprising receiving amount information to specify a purchase amount of the digital currency, with respect to the user account,
wherein in the starting of the electronic payment process, whenever the payment event occurs, a price corresponding to the amount information is specified as a payment object price to be paid through the electronic payment process, by using the amount information.

4. The method of claim 3, further comprising supplying the digital currency as much as the specified purchase amount to the user account, based on completion of the electronic payment process,
wherein in the supplying of the digital currency, an additional amount of the digital currency besides the specified purchase amount is supplied based on the number of times that the electronic payment process has been completed.

5. The method of claim 4, wherein the additional amount of the digital currency supplied to the user account becomes different according to a degree of the specified purchase amount.

6. The method of claim 4, further comprising checking a payment history related to the user account based on completion of the electronic payment process,
wherein when the number of times that the electronic payment process has been completed at the user account is one as a check result of the payment history, the additional amount of the digital currency is supplied to the user account.

7. The method of claim 4, further comprising counting the number of times of completion of the electronic payment process based on an occurrence of the payment event,
wherein the additional amount of the digital currency is supplied at every preset specific number of times based on a result of the counting.

8. The method of claim 7, further comprising storing a payment history including the number of times that the electronic payment process has been completed at the user account, based on reception of a request to stop a purchase function of the digital currency, the function for starting the payment process according to the payment event for the user account.

9. The method of claim 8, wherein the payment process is not started even when the payment event which satisfies the payment condition occurs at the user account, after a time period from when the stop of the purchase function is requested.

10. The method of claim 8, further comprising releasing the stop of the purchase function with respect to the user account, after a preset time period from the time when the stop of the purchase function is requested,
wherein in the monitoring of the payment event, it is monitored whether a payment event which satisfies the payment condition has occurred at the user account after the stop of the purchase function is released.

11. The method of claim 2, wherein the payment condition is differently set according to the specific payment type, among the plurality of different payment types.

12. The method of claim 11, wherein a first payment type among the plurality of different payment types is a payment type where the payment event occurs on a basis of an amount of digital currency already retained at the user account, and
wherein a second payment type among the plurality of different payment types, different from the first payment type, is a payment type where the payment event occurs on a basis of a date.

13. The method of claim 12, wherein in a case where the specific payment type is the first payment type, the payment condition is related to a minimum amount of the digital currency retained at the user account, and
wherein in the monitoring of the payment event, it is determined that the payment event has occurred when an amount of the digital currency retained at the user account does not satisfy the minimum amount.

14. The method of claim 12, wherein in a case where the specific payment type is the second payment type, the payment condition is related to a date preset in connection with the user account, and
wherein in the monitoring of the payment event, it is determined that the payment event has occurred in a case where a current date when the monitoring is being performed corresponds to the preset date.

15. The method of claim 2, wherein the payment condition is changed based on a request from the user account, and
wherein in a case where the payment condition is changed, in the monitoring of the payment event, it is monitored whether a payment event which satisfies the changed payment condition occurs at the user account.

16. The method of claim 1, wherein the contents include of at least one episode, and
wherein each of the at least one episode has one of a charged product type which can be viewed through a payment of the digital currency, and a free product type which can be viewed without a payment of the digital currency.

17. The method of claim 16, wherein a charged product type of a specific episode, among the at least one episode is converted into a free product type based on lapse of a preset time.

18. An electronic payment system for performing a payment related to digital currency used to view contents, the system comprising:
a communication unit configured to receive selection information for selecting a specific payment type among a plurality of different payment types related to the digital currency, in relation to a user account; and
a controller configured to register a payment condition corresponding to the specific payment type to the user account by using the selection information,
wherein the controller starts an electronic payment process to purchase the digital currency for the user account in response to an occurrence of a payment event related to the payment condition at the user account.

19. A non-transitory computer-readable recording medium storing a program for purchasing digital currency used for viewing contents, said program causing a computer to execute the steps comprising:
receiving selection information for selecting a specific payment type among a plurality of different payment types related to digital currency, in relation to a user account;
registering a payment condition corresponding to the specific payment type to the user account by using the selection information; and
starting an electronic payment process to purchase the digital currency for the user account in response to an occurrence of a payment event related to the payment condition at the user account.
